(19) United States
(12) Patent Application Publication
(10) Pub. No.: US 2001/0017993 A1
(43) Pub. Date: Aug. 30, 2001

(54) Image forming apparatus

(75) Inventor: Isao Kubota, Niigata (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/789,739

(22) Filed: Feb. 22, 2001

(30) Foreign Application Priority Data
Feb. 28, 2000 (JP) 2000-050632

(51) Int. Cl. G03G 15/08; G03G 15/16

(52) U.S. Cl. 399/121; 399/122

(57) ABSTRACT

A transfer roller and a fixing roller facilitate maintenance, such as upon occurrence of failure. A transfer roller unit rotatably supports a transfer roller contacting with an endless belt form image carrier driven to circulate in an auxiliary scanning direction under pressure, and being driven for rotation. A fixing roller unit rotatably supports a fixing roller which is in contact with said transfer roller across a printing medium under pressure for fixing a developed image transferred from said transfer roller to said printing medium. The transfer roller and the fixing roller being detachably installed on a frame of a transfer and fixing portion of said image forming apparatus.

### BACKGROUND OF THE INVENTION

1. Field of the Invention

The present invention relates generally to an image forming apparatus, such as a color printer or the like. More particularly, the invention relates to an image forming apparatus employing a transfer roller which is driven to rotate in a condition contacted under pressure with a surface of an endless belt form image carrier circulating in an auxiliary scanning direction and a fixing roller for fixing a developed image on the transfer roller transferred from the image carrier on a printing medium, in a transfer and fixing portion.

2. Description of the Related Art

Conventionally, the image forming apparatus of the type set forth above, is frequently provided with a transfer roller and a fixing roller incorporated a head source therein in a transfer and fixing portion. In order to establish pressure contact between these rollers, a bearing biasing mechanism is employed for biasing a bearing of a roller shaft to cause a difficulty for end user to take a measure upon exchange due to end of lift time, or occurrence of trouble. On the other hand, while it is not likely that both of the transfer roller and the fixing roller reach the end of lift simultaneously, the conventional image forming apparatus does not permit to exchange the transfer roller and the fixing roller independent of the other.

### SUMMARY OF THE INVENTION

It is an object of the present invention to form a transfer roller and a fixing roller which are required to exchange, as respectively independent units to facilitate maintenance, such as upon occurrence of failure.

Another object of the present invention is to prevent the unit of the transfer roller or the fixing roller from falling down upon exchanging and from being injured or damaged by collision with other parts by surrounding circumferences of the transfer roller and the fixing roller with a frame body and to permit significant reduction of a period required for exchanging operation.

A further object of the present invention is to achieve higher efficiency of a heat source installed within the roller by surrounding circumferences of the transfer roller and the fixing roller with a frame body.

According to one aspect of the present invention, an image forming apparatus comprises:

a transfer roller unit rotatably supporting a transfer roller contacting with an endless belt form image carrier driven to circulate in an auxiliary scanning direction under pressure, and being driven for rotation; and

a fixing roller unit rotatably supporting a fixing roller which is in contact with the transfer roller across a printing medium under pressure for fixing a developed image transferred from the transfer roller to the printing medium,

the transfer roller and the fixing roller being detachably installed on a frame of a transfer and fixing portion of the image forming apparatus.

Each of the transfer roller unit and the fixing roller unit may comprise:

movable holder detachably holding each of the transfer roller unit and the fixing roller unit;

a biasing mechanism biasing the movable holder holding the fixing roller unit for contacting the fixing roller onto the transfer roller under pressure;

a biasing mechanism biasing the movable holder holding the transfer roller unit for urging the transfer roller onto the image carrier.

The image forming apparatus may further comprise insertion guide for guiding each of the transfer roller unit and the fixing roller unit upon attaching and detaching each of the transfer roller unit and the fixing roller unit to the movable holder.

Also, the image forming apparatus may further comprise insertion angle guide for gradually varying angular position of each of the transfer roller unit and the fixing roller unit when each of the transfer roller unit and the fixing roller unit is inserted to be held in the movable frame as guided by the insertion guide.

Each of the transfer roller unit and the fixing roller unit may be provided with guide pin slidably contacting with the insertion guide and detect portion slidably contacting with the insertion angle guide at an end portion in insertion direction.

The transfer roller unit may be formed into a unit by rotatably supporting the transfer roller incorporating a heat source therein within a frame body.

The fixing roller unit may be formed into a unit by rotatably supporting the fixing roller incorporating a heat source therein within a frame body.

A frame of a transfer and fixing portion may be pivotably mounted on an image forming apparatus main body for pivoting between open and closed positions.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a schematic and diagrammatic illustration showing a construction of one embodiment of an image forming apparatus according to the present invention;

FIG. 2 is a perspective view showing a transfer roller unit and a fixing roller unit in one embodiment of the image forming apparatus;

FIGS. 3A and 3B show sections showing the transfer roller unit and the fixing roller unit together, in which FIG. 3A is a section in a direction perpendicular to a roller shaft and FIG. 3B is a section along an axial direction of the roller;

FIG. 4 is a structural illustration showing a condition where the transfer roller unit and the fixing roller unit are mounted;

FIG. 5 is a perspective view showing the transfer roller and the fixing roller unit together with engagement relationship with an insertion guide and an insertion angle guide;

FIG. 6 is a structural illustration showing a condition of maintenance of the fixing roller unit;

FIG. 7 is a structural illustration showing a condition upon insertion of the fixing roller unit; and

FIG. 8 is a structural illustration showing a condition upon insertion of the transfer roller unit.

### DESCRIPTION OF THE PREFERRED EMBODIMENT

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structure are not shown in detail in order to avoid unnecessary obscurity of the present invention.

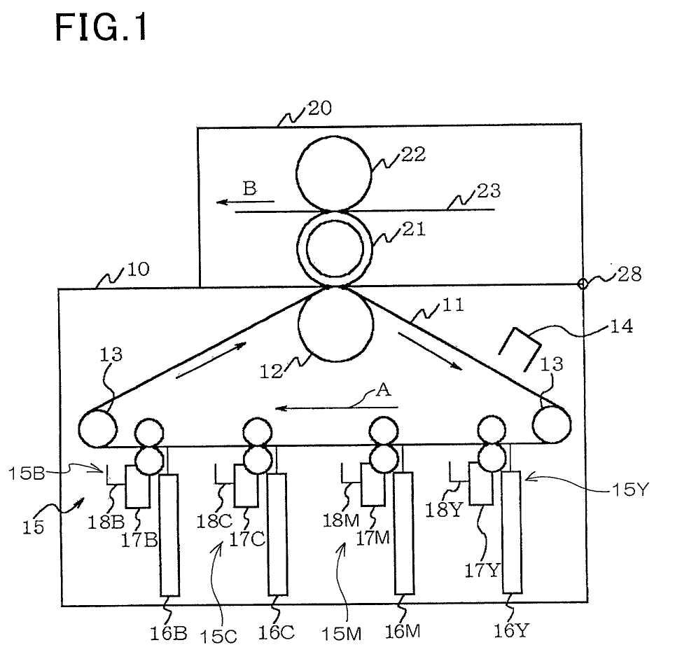

FIG. 1 is a schematic and diagrammatic illustration showing a construction of one embodiment of an image forming apparatus according to the present invention. In FIG. 1, the shown embodiment of an image forming apparatus is constructed with an image forming apparatus main body 10 and a transfer and fixing portion 20. The transfer and fixing portion 20 can be pivoted on the image forming apparatus main body 10 to open and close about a pivot point 28 with respect to the image forming apparatus main body 10. The image forming apparatus main body 10 has an endless belt form image carrier 11. The image carrier 11 is wrapped around two image carrier driver rollers 13 and one transfer back-up roller 12 to be driven for circulation in s direction of arrow A (auxiliary scanning direction) by a driving force from an image carrier driver rollers 1. Around the endless belt form image carrier 11, a charger 14 and a developing portion 15 are arranged.

In the image forming apparatus, the image carrier 11 is uniformly charged by he charger 14 to form an electrostatic latent image on the image carrier 11 by exposure by a scanning light from a light source. Then, after development by the developing portion 15, the developed image on the image carrier 11 is transferred to a printing paper 23 fed to the transfer and fixing portion 20 and then fixed thereon.

The transfer and fixing portion 20 has a transfer roller 21 and a fixing roller 22 respectively formed as independent units. These transfer roller 21 and the fixing roller 22 have heat sources therein, respectively. The transfer roller 21 rotates with contacting with the surface of the image carrier 11 under pressure. The fixing roller 22 is constructed rotate with contacting with the transfer roller 21 under pressure. By a nip portion of these rollers 21 and 22, the printing paper 23 as the printing medium is gripped and transported, Then, the developed image on the image carrier 11 is transferred to the paper 23 by the transfer roller 21, and the transferred image is fixed on the printing paper 23 by the fixing roller 22.

The charger 14 is arranged in opposition to the surface of the image carrier 11 and applies a uniform charge on the surface of the image carrier 11 circulating together with initiation of printing operation for charging.

The developing portion 15 as generally referred to is divided into developing portions 15Y, 15M, 15C and 15B for four colors of yellow, magenta, cyan and black. Respective developing portions 15Y, 15M, 15C and 15B includes light sources 16Y, 16M, 16C and 16B, developers 17Y, 17M, 17C and 17B and sub-chargers 18Y, 18M, 18C and 18B. For example, the developing portion 15Y scans the light source 16Y on the image carrier 11 to form electrostatic latent image on the image carrier 11. The electrostatic latent image on the image carrier 11 is developed by the developer 17Y arranged at downstream of the process. Particularly, by a liquid toner in the developer, an image is formed on the image carrier 11. Furthermore, by the sub-charger 18Y arranged at downstream of the process of the developer 17Y, uniform charging is performed on the image carrier 11, again. Other developers 15M, 15C and 15B also perform similar developing operation by the developers 17M, 17C and 17B and the sub-chargers 18M, 18C and 18B to form the color image on the image carrier 11.

The color image on the image carrier 11 is transferred to the transfer roller 21 by a heat and a pressure applied at the nip portion between the transfer back-up roller 12 and the transfer roller 21 having a heat source therein. At this time, the printing paper 23 is picked up from a hopper (not shown) by a pick-up roller (not shown) and fed to the nip portion between the transfer roller 21 and the fixing roller 22.

Next, the color image is fixed on the printing paper 23 by the heat and pressure in the nip portion between the transfer roller 21 having the heat source and the fixing roller 22 having the heat source. As set forth above, the image forming apparatus forms the color image on the printing paper through a series of image forming process.

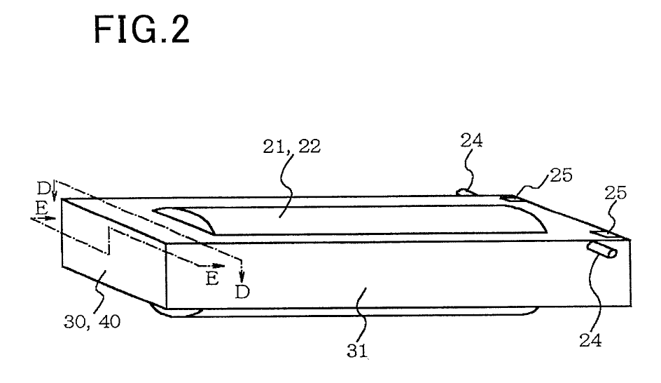

FIG. 2 is a perspective view showing mutually independent a transfer roller unit 30 and a fixing roller unit 40 together. The transfer roller unit 30 and the fixing roller unit 40 have the same structure while the transfer roller unit 30 has greater length than that of the fixing roller unit 40. The transfer roller unit 30 rotatable supports the transfer roller 21 within a rectangular frame body 31. Guide pins 24 project from both side surfaces of one end longitudinal end (end portion on insertion side) of the frame body 31. At both corner portions on upper end of the same end portion of the frame body 31, detent portions 25 are provided. The fixing roller unit 40 rotatable supports the fixing roller 22 within a rectangular frame body 31. Guide pins 24 are projected from both side surfaces of one end longitudinal end (end portion on insertion side) of the frame body 31. At both corner portions on upper end of the same end portion of the frame body 31, detent portions 25 are provided.

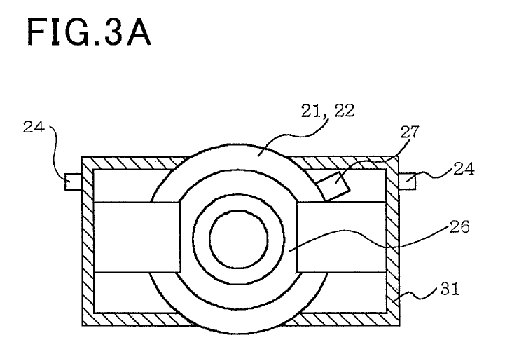

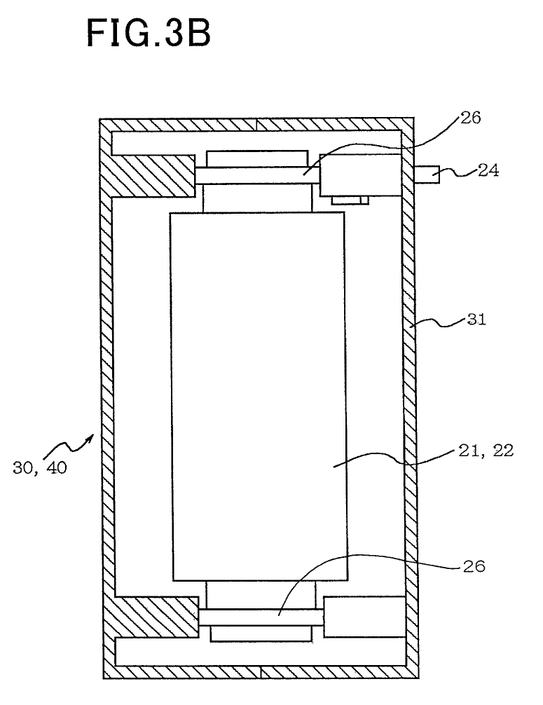

FIGS. 3A and 3B are sections showing the transfer roller unit 30 and the fixing roller unit 40 together in combined form, in which FIG. 3A is a section taken along line D-D of FIG. 2, and FIG. 3B is a section taken along line E-E of FIG. 2. The transfer unit 30 rotatably supports a roller shaft of the transfer roller 21 within the frame body 31 by a pair of bearings 26. Similarly, the fixing roller unit 40 rotatably supports a roller shaft of the fixing roller 22 within the frame body 31 by a pair of bearings 26. On the other hand, within each of the frame 31, a thermistor 27 for detecting a temperature on a peripheral surface of the roller as heated by the heat source (not shown) arranged within each of the transfer roller 21 and the fixing roller 22, is fixed so as to permit control of the heat source by a controller of the image forming apparatus.

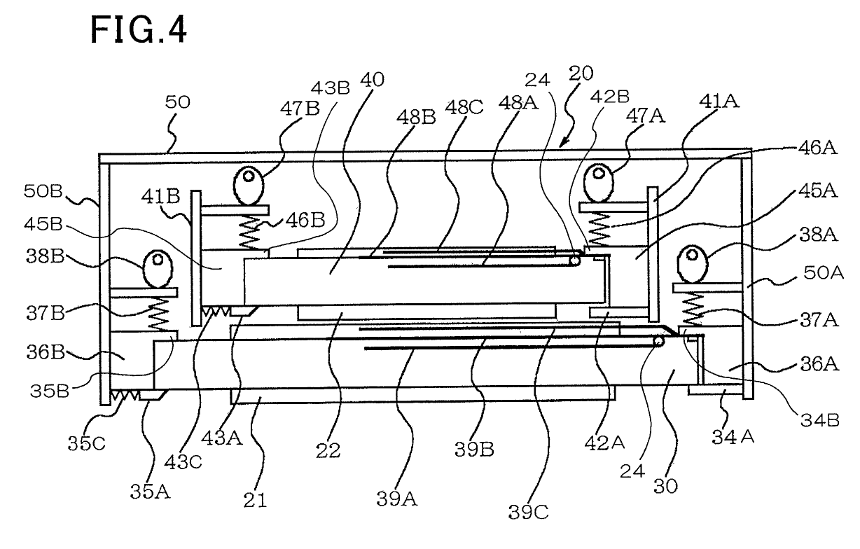

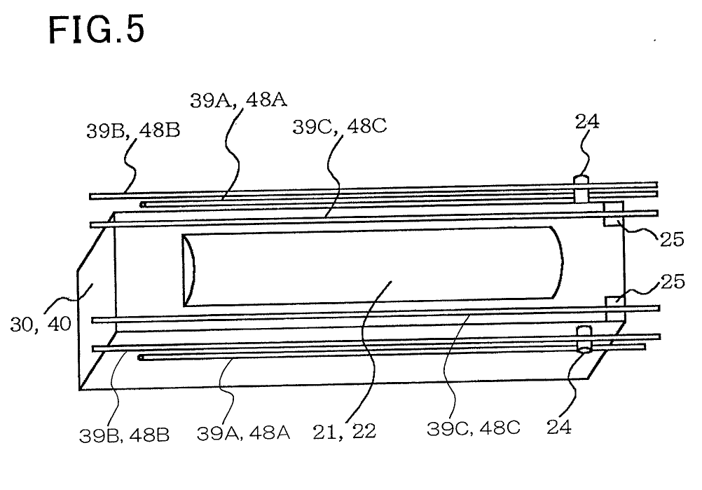

FIG. 4 is an illustration showing the internal structure of the transfer and fixing portion 20. On the other hand, FIG. 5 is a perspective view showing the transfer roller unit 30 and the fixing roller unit 40 together relationship of the mounting position with the insertion guide and the insertion angle guide. The transfer and fixing portion 30 is constructed by placing the transfer roller unit 30 at upper side and the fixing roller unit 40 at lower side within a lower side opened box shaped outer frame 50 in a manner detachable independently with each other.

On the side plates 51A and 51B on both sides of the outer frame 50, a pair of movable holders 36A and 36B for holding the transfer roller unit 30 are installed in vertically movable fashion. The transfer roller unit 30 is detachably held by the movable holders 36A and 36B. The movable holder 36A is biased downwardly by a biasing mechanism constructed by a spring 37A and a cam 38A. Similarly, the movable holder 36B is also constructed to be downwardly biased by a biasing mechanism constructed by a spring 37B and a cam 38B. The biasing force is adjustable by angular position of the cams 38A and 38B. By the biasing force, the transfer roller 21 of the transfer roller unit 30 held by a pair of movable holders 36A and 36B is biased toward the image carrier 11 from the above on the transfer back-up roller 12 on the side of the image forming apparatus main body.

In the movable holder 36A, two sets of insertion guides for guiding insertion of the transfer roller unit 30 between the movable holders 36A and 36B, are provided on both sides of the transfer roller unit 30. Namely, each set of the insertion guide is constructed with two bar shaped insertion guides 39A and 39B and the same one bar shaped insertion angle guide 39C. As shown in FIG. 5, these are installed on the movable holder 36A in parallel to the longitudinal axis of the transfer roller 21. It should be noted that the insertion guides 39A and 39B and the insertion angle guide 39C may also be provided outside of the outer frame 50.

The insertion guides 39A and 39B extend in straight over the entire length. By sliding the guide pins 24 projecting from the frame body 31 of the transfer roller unit 30 along the insertion guides 39A and 39B, the transfer roller unit 30 is guided.

The insertion angle guide 39C is downwardly tilted the base end portion in order to gradually vary the attitude of the transfer roller unit 30 by contacting with the upper surface of the transfer roller unit 30 upon holding the transfer roller unit 40 between the movable holders 36A and 36B.

One movable holder 36A has an upper side projecting portion 34B for detachably engaging with the end portion of the transfer roller unit 30 on insertion side, and is rigidly secured a lower receptacle plate 34A.

The other movable holder 36B has a projecting portion 35B on the upper side thereof and is facilitated detaching of the end at the opposite side of the insertion side of the transfer roller unit 30 by slidably mounting a lower receptacle plate 35A with biasing the same by means of a spring 35C.

The transfer roller unit 30 is held between a pair of movable holders 36A and 36B in the following manner. The transfer roller unit 30 is inserted with positioning guide pins 24 on both sides of the frame body 31 between the insertion guides 39A and 39B at both sides for sliding along the latter, and slidably contacting the detent portions 25 with the insertion angle guide 39C on both ends to at first engage the end portion of the transfer roller unit 30 on insertion side between the upper projecting portion 34B and the lower reception plate 34A. Then, the lower receptacle plate 35A of the other movable holder 36B is at the retracted position against the spring force of the spring 35C, and the transfer roller unit 30 is lifted up until the end portion of the transfer roller unit 30 oil opposite side to the insertion side contacts with the upper side projection 35B of the movable holder 36B. Thereafter, the lower receptacle plate 35A is returned to an initial position to engage the end portion of the transfer roller unit 30 on the opposite side of the insertion side between the upper side projecting portion 35B and the lower side receptacle plate 35A of the movable holder 36B. By this, the transfer roller unit 30 is held by a pair of movable holders 36A and 36B.

On the other hand, a pair of movable holder 45A and 45B for holding the fixing roller unit 40 are mounted on the side plates 41A and 41B on both sides of an inner frame provided within an external frame 50 for vertical movement. The fixing roller unit 40 is detachably held by the movable holders 45A and 45B. The movable holder 45A is biased downwardly by a biasing mechanism consisted of a spring 46A and a cam 47A. Similarly, the movable holder 45B is also biased downwardly by a biasing mechanism consisted of a spring 46B and a cam 47B. The biasing forces are adjustable by the angular position of the cams 47A and 47B. By the biasing force, the fixing roller 22 of the fixing roller unit 40 held by a pair of movable holders 45A and 45B is urged toward the transfer roller 21 of the transfer roller unit 30 from the above.

Similarly to the case of the transfer roller unit 30, two sets of insertion guides are provided on both sides of the fixing roller unit 40 for insertion of the fixing roller unit 40 between a pair of movable holders 45A and 45B. Namely, each set of the insertion guide is constructed with two bar shaped insertion guides 48A and 48B and one bar shaped insertion angle guide 48C. As shown in FIG. 5, these are installed on the movable holder 45A in parallel to an axis of the fixing roller 22. It should be noted that the insertion guides 48A and 48B and the insertion angle guide 48C are mounted on the inner frame.

The insertion guides 48A and 48B extend in straight over the entire length. By sliding the guide pins 24 projecting from the frame body 31 of the fixing roller unit 40 along the insertion guides 48A and 48B, the fixing roller unit 40 is guided.

The insertion angle guide 48C is downwardly tilted the base end portion in order to gradually vary the attitude of the fixing roller unit 40 by contacting with the upper surface of the fixing roller unit 40 upon holding the fixing roller unit 40 between the movable holders 45A and 45B.

One movable holder 45A has an upper side projecting portion 42B for detachably engaging with the end portion of the transfer roller unit 30 on insertion side, and is rigidly secured a lower receptacle plate 42A.

The other movable holder 45B has a projecting portion 43B on the upper side thereof and is facilitated detaching of the end at the opposite side of the insertion side of the fixing roller unit 40 by slidably mounting a lower receptacle plate 43A with biasing the same by means of a spring 43C.

The fixing roller unit 40 is held between a pair of movable holders 45A and 45B in the following manner. The fixing roller unit 40 is inserted with positioning guide pins 24 on both sides of the frame body 31 between the insertion guides 48A and 48B at both sides for sliding along the latter, and slidably contacting the detent portions 25 with the insertion angle guide 48C on both ends to at first engage the end portion of the fixing roller unit 40 on insertion side between the upper projecting portion 42B and the lower reception plate 42A. Then, the lower receptacle plate 43A of the other movable holder 45B is at the retracted position against the spring force of the spring 43C, and the fixing roller unit 40 is lifted up until the end portion of the fixing roller unit 40 on opposite side to the insertion side contacts with the upper side projection 43B of the movable holder 45B. Thereafter, the lower receptacle plate 43A is returned to an initial position to engage the end portion of the fixing roller unit 40 on the opposite side of the insertion side between the upper side projecting portion 43B and the lower side receptacle plate 43A of the movable holder 45B. By this, the fixing roller unit 40 is held by a pair of movable holders 45A and 45B.

As set forth above, the fixing roller 40 held by the movable holders 45A and 45B feeds the printing paper 23 as set forth above, by the fixing roller 22 and the transfer roller 24 since the movable holders 45A and 45B are biased downwardly by biasing mechanism as set forth above.

On the other hands, the life times of the transfer roller 21 in the of the transfer roller unit and the fixing roller 22 of the fixing roller unit 40 are generally shorter than the life time of the image forming apparatus main body 10. Therefore, after performing printing in amount greater than or equal to a given amount. or upon maintenance, such as that upon appeal.

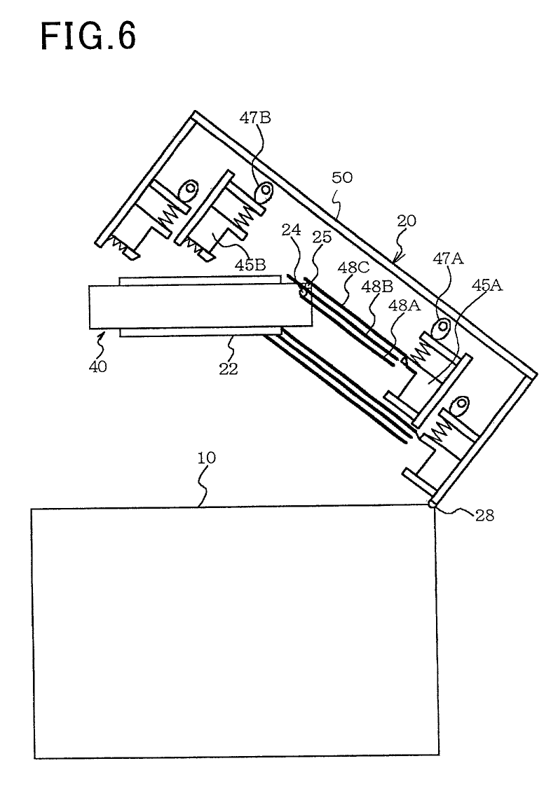

FIG. 6 shows a condition of maintenance operation of the image forming apparatus. In FIG. 6, the transfer end fixing portion can be freely opened and closed about a rotational center 28 with respect to the image forming apparatus. Therefore, upon detaching the fixing roller unit 40, the transfer and fixing portion 20 is opened to detach or disassemble the fixing roller unit 40, the transfer and fixing portion 20 is opened, and the fixing roller unit 40 is disassembled with maintaining the same horizontal. By the similar method, the transfer roller 30 may also be detached or disassembled.

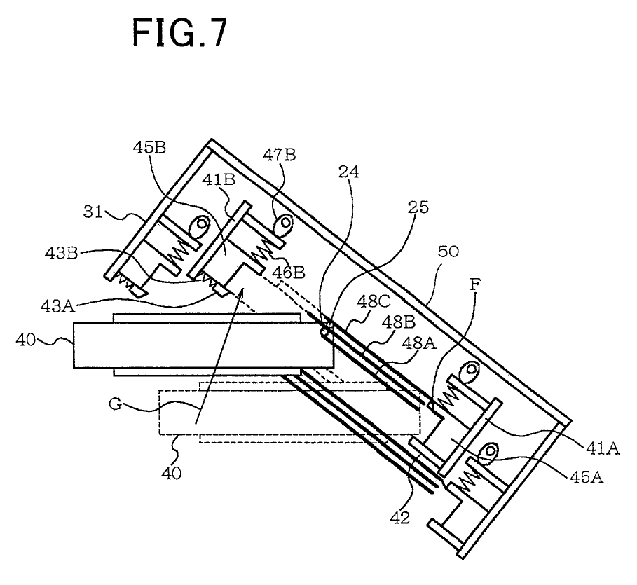

FIG. 7 shows an inserting condition of the fixing roller unit 40. In FIG. 7, the fixing roller unit 40 is inserted by sliding the guide pins 24 along the insertion guides 48A and 48B. Since the detent portions 25 slidingly contact with the insertion angle guide, the fixing roller unit 40 can be inserted within the external frame with maintaining the horizontal attitude.

By applying a force in a direction of allow G when the fixing roller unit 40 is inserted up to the position F shown in FIG. 7, the detent portion 25 moves along the tilted portion at the base end of the insertion angle guide 40C to gradually vary the attitude (angle) from the horizontal position to be placed at an angular position adapting to the angle of the external frame 50 which is held opened. Then, the fixing roller unit 40 is smoothly held by the movable holders 45A and 45B.

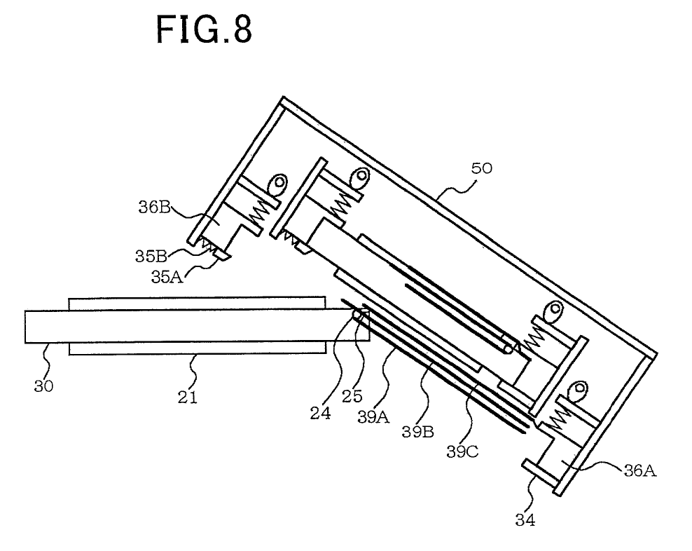

FIG. 8 shows the transfer roller unit 30 in inserting condition. In FIG. 8, the transfer roller unit 30 is inserted by sliding the guide pins 24 along the insertion guides 39A and 39B. Since the detent portions 25 slidingly contact with the insertion angle guide 39C, the transfer roller unit 30 can be inserted within the external frame 50 with maintaining the horizontal attitude. Then, similarly to the case of the fixing roller unit 40 as set forth above, the transfer roller unit 30 is gradually varied the attitude from the horizontal position to be placed at an angular position adapting to the angle of the external frame 50 which is held opened. Then, the transfer roller unit 30 is smoothly held by the movable holders 36A and 36B.

As set forth above, the image forming apparatus according to the present invention can facilitate maintenance upon occurrence of failure by forming the transfer roller and the fixing roller which are required exchange as respectively independent units. Namely, the transfer roller and the fixing roller can be exchanged without requiring disassembling to be end user.

Also, by providing the insertion guide and the insertion angle guide which makes insertion angle, falling down of the unit upon exchanging and injury and damage due to contacting with other hand, a period required for exchanging can be shortened significantly.

Furthermore, since the present invention requires the frame body surrounding the roller, efficiency of the heat source can be improved.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. An image forming apparatus comprising:
a transfer roller unit rotatably supporting a transfer roller contacting with an endless belt form image carrier driven to circulate in an auxiliary scanning direction under pressure, and being driven for rotation; and
a fixing roller unit rotatably supporting a fixing roller which is in contact with said transfer roller across a printing medium under pressure for fixing a developed image transferred from said transfer roller to said printing medium,
said transfer roller and said fixing roller being detachably installed on a frame of a transfer and fixing portion of said image forming apparatus.

2. An image forming apparatus as set forth in claim 1, wherein each of said transfer roller unit and said fixing roller unit comprises:
movable holder detachably holding each of said transfer roller unit and said fixing roller unit;
a biasing mechanism biasing said movable holder holding said fixing roller unit for contacting said fixing roller onto said transfer roller under pressure;
a biasing mechanism biasing said movable holder holding said transfer roller unit for urging said transfer roller onto said image carrier.

3. An image forming apparatus as set forth in claim 2, which further comprises insertion guide for guiding each of said transfer roller unit and said fixing roller unit upon attaching and detaching each of said transfer roller unit and said fixing roller unit to said movable holder.

4. An image forming apparatus as set forth in claim 3, which further comprises insertion angle guide for gradually varying angular position of each of said transfer roller unit and said fixing roller unit when each of said transfer roller unit and said fixing roller unit is inserted to be held in said movable frame as guided by said insertion guide.

5. An image forming apparatus as set forth in claim 4, wherein each of said transfer roller unit and said fixing roller unit is provided with guide pin slidably contacting with said insertion guide and detect portion slidably contacting with said insertion angle guide at an end portion in insertion direction.

6. An image forming apparatus as set forth in claim 1, wherein said transfer roller unit is formed into a unit by rotatably supporting said transfer roller incorporating a heat source therein within a frame body.

7. An image forming apparatus as set forth in claim 1, wherein said fixing roller unit is formed into a unit by rotatably supporting said fixing roller incorporating a heat source therein within a frame body.

8. An image forming apparatus as set forth in claim 1, wherein a frame of a transfer and fixing portion is pivotably mounted on an image forming apparatus main body for pivoting between open and closed positions.
